(19) United States
(12) Patent Application Publication
(10) Pub. No.: US 2024/0385134 A1
(43) Pub. Date: Nov. 21, 2024

(54) HERMETICALLY SEALED SAMPLE PAN AND DEVICE FOR UNSEALING SAME

(71) Applicant: TA Instruments-Waters LLC, New Castle, DE (US)

(72) Inventors: Xiaoping Hu, New Castle, DE (US); Amichai Shdaimah, Ardmore, PA (US); Keyvan Safaei, Newark, DE (US); Christopher Ubelacker, West Chester, PA (US)

(21) Appl. No.: 18/662,417

(22) Filed: May 13, 2024

Related U.S. Application Data
(60) Provisional application No. 63/466,447, filed on May 15, 2023.

(51) Int. Cl. G01N 25/48; B01L 3/00

(52) U.S. Cl. CPC G01N 25/486; B01L 3/5027; G01N 25/482; G01N 25/4833; B01L 2300/044; B01L 2300/0672; B01L 2300/18

(57) ABSTRACT

A device for unsealing a sample pan for a thermal analysis instrument includes a sample pan holder, an actuator element and a punch element. The sample pan holder is configured to secure the sample pan in a fixed position with respect to the sample pan holder. The actuator element is secured to the sample pan holder and is formed of a thermally sensitive material that changes the shape of the actuator element in response to a change in an external temperature to a transition temperature. The punch element is attached to the actuator element and is positioned with respect to the sample pan such that the change in the shape of the actuator element in response to the change in the external temperature moves the punch element to puncture the sealing element to thereby expose the internal volume of the sample pan to an external environment.

### RELATED APPLICATION

This application claims the benefit of the earlier filing date of U.S. Provisional Patent Application Ser. No. 63/466,447 filed May 15, 2023 and titled “Hermetically Sealed Sample Pan and Device for Unsealing Same,” the entirety of which is incorporated herein by reference.

### FIELD OF THE INVENTION

The disclosed technology relates to thermal analysis of sample materials. More particularly, the technology relates to a sample pan for a thermal analysis instrument and a device for unsealing a sealed sample pan.

### BACKGROUND

In thermal analyses, a sample to be evaluated is put in a container such as a sample pan before the pan is placed in a thermal analysis instrument. The internal environment of the instrument is typically purged with an inert gas. For some experiments, the sample pan is sealed to prevent the sample from being exposed to air and moisture prior to initiation of the experiment. The seal is then punctured or otherwise opened or removed just before the pan is loaded into the instrument. In this process, there is a period which the sample is exposed to the surrounding air. This period starts when the seal is first broken and the pan is loaded into the instrument until the instrument is closed and the internal environment is fully purged with the inert gas. This period of exposure can be detrimental to experimental results for some samples.

To address the above problem, the thermal analysis instrument is often located inside a glove box. Sample preparation is performed inside the glove box and therefore the sample exposure is limited to the glove box environment which typically includes an inert gas. The glove box limits the oxygen and moisture levels present in the environment. While providing reduction in exposure to the room environment, the glove box may require a large volume to accommodate the instrument. Moreover, if a glove box is required for other purposes, sharing the glove box may limit the time during which the glove box is available for thermal analysis experiments. Alternatively, the glove box may be dedicated to the thermal analysis instrument; however, other uses for a glove box would require an additional unit which represents additional cost.

### SUMMARY

In one aspect, a sample pan for a thermal analysis instrument includes a pan body and a sealing element. The pan body has an internal volume to receive a sample and a gas path extending from the internal volume to an external surface of the pan body. The sealing element is disposed in the gas path to obstruct the gas path and thereby seal the internal volume from an external environment. The sealing element includes a thermally sensitive material that changes a shape of the sealing element in response to a change in a temperature of the external environment to a transition temperature. The change in shape exposes the internal volume to the external environment through the gas path.

The sealing element may include a plug made of a shape memory material such as a shape memory metal, alloy or polymer. The shape memory material may be a two-way shape memory material.

The sealing element may be disposed on the external surface of the pan body at an end of the gas path. The sealing element may be a seal ring disposed between internal surfaces of the pan body. The pan body may have a circumferential wall with a channel therein and the sealing element may be a seal ring disposed on the external surface of the circumferential wall.

The sealing element may include a plug made of a material having a melting temperature at the transition temperature. The sealing element may include a metallic plug having a surface with a meltable layer formed on the surface.

The sealing element may include a plug disposed in the gas path and an actuator element coupled to the plug. The actuator may be made of a shape memory metal and have a shape that changes in response to the change in the temperature of the external environment to a transition temperature. The change in the shape of the actuator element removes the plug from the gas path. The shape memory metal may be a two-way shape memory metal. The actuator element may be a spring made of a shape memory metal.

The change in the temperature of the external environment to a transition temperature to expose the internal volume to the external environment may be an increase in temperature or a decrease in temperature.

The pan body may include a plurality of body parts that are secured to each other.

The sample pan may hold a sample during measurement by a thermal analysis instrument and the transition temperature may be less than a lowest temperature in a measurement temperature range.

In another aspect, a method for preparing a sample for a thermal analysis instrument includes loading a sample into an internal volume of a sample pan. The sample pan has a gas path from the internal volume through the sample pan to an external environment. The sample is sealed in the sample pan by a sealing element that obstructs the gas path from the internal volume to the external environment. The sealing element includes a thermally sensitive material that changes a shape of the sealing element in response to a change in a temperature of the external environment to a transition temperature. The method continues with loading the sample pan into the thermal analysis instrument and operating the thermal analysis instrument to change a temperature of the external environment of the sample pan to at least the transition temperature. The change in the shape removes the obstruction from the gas path so that the internal volume communicates with the external environment.

The external environment bay be defined inside the thermal analysis instrument and the method may further include purging the external environment with a user-selected gas after the step of loading the sample pan and before the step of operating the thermal analysis instrument to change the temperature of the external environment.

Operating the thermal analysis instrument may include increasing or decreasing the temperature of the external environment of the sample pan. Operating the thermal analysis instrument may include changing the temperature through a measurement temperature range that does not include the transition temperature.

In another aspect, a device for unsealing a sample pan for a thermal analysis instrument includes a sample pan holder, an actuator element and a punch element. The sample pan holder is configured to secure a sample pan in a fixed position with respect to the sample pan holder. The actuator element is secured to the sample pan holder and is formed of a thermally sensitive material that changes a shape of the actuator element in response to a change in an external temperature to a transition temperature. The punch element is attached to the actuator element and is disposed at a position with respect to the sample pan such that the change in the shape of the actuator element in response to the change in the external temperature moves the punch element to puncture the sealing element. The puncture of the sealing element exposes the internal volume of the sample pan to an external environment.

The actuator element may be a coil spring made of a shape memory metal. The change in the shape of the actuator element may be a change in a length of the coil spring.

The actuator element may be a spiral coil made of a shape memory metal. The change in the shape of the actuator element may be a change from a non-planar configuration of the spiral coil to a planar configuration.

In another aspect, a method for preparing a sample for a thermal analysis instrument includes securing a sample pan in a device for unsealing the sample pan. The device includes a sample pan holder, an actuator element and a punch element. The sample pan holder is configured to secure a sample pan in a fixed position with respect to the sample pan holder. The actuator element is secured to the sample pan holder and is formed of a thermally sensitive material that changes a shape of the actuator element in response to a change in an external temperature to a transition temperature. The punch element is attached to the actuator element and is disposed at a position with respect to the sample pan such that the change in the shape of the actuator element in response to the change in the external temperature moves the punch element to puncture a sealing element on the sample pan to thereby expose the internal volume of the sample pan to an external environment. The method further includes loading the device into a thermal analysis instrument and changing a temperature of the thermal analysis instrument to a transition temperature to change the shape of the actuator element. As a result, the punch element moves to puncture the sealing element.

The actuator element may be a coil spring and the change in the shape of the actuator element may be a change in a length of the coil spring.

The actuator element may be a spiral coil and the change in the shape of the actuator element may be a change from a non-planar configuration of the spiral coil to a planar configuration.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1A is an exploded view of an example of a sample pan for a thermal analysis instrument and FIGS. 1B and 1C are cross-sectional views of the sample pan in a hermetically sealed state and an unsealed state, respectively.

FIGS. 2A and 2B are cross-sectional views of a sample pan shown in a hermetically sealed state and an unsealed state, respectively, and having a plug that includes a layer of a meltable material.

FIGS. 3A and 3B are cross-sectional views of a sample pan in a hermetically sealed state and an unsealed state, respectively, which utilizes a shape memory metal plug for a sealing element.

FIGS. 4A and 4B are cross-sectional views of a sample pan in a hermetically sealed state and an unsealed state, respectively, which utilizes a sealing element in the form of a seal ring.

FIGS. 5A and 5B are cross-sectional views of a sample pan in a hermetically sealed state and an unsealed state, respectively, which utilizes a shape memory metal actuator and a seal plug.

FIGS. 6A and 6B are cross-sectional views of a sample pan in a hermetically sealed state and an unsealed state, respectively, which utilizes a shape memory metal spring and a seal plug.

FIGS. 7A and 7B are cross-sectional views of a sample pan in a hermetically sealed state and an unsealed state, respectively, and FIG. 7C is a perspective view of the sample pan in an unsealed state, wherein the sample pan utilizes a two-way shape memory metal seal ring.

FIG. 8 is a flowchart representation of an example of a method for preparing a sample for a thermal analysis instrument.

FIG. 9 is an example of a hermetically sealed sample pan that can be used with a thermal analysis instrument.

FIGS. 10A and 10B are a side view and a cross-sectional perspective view, respectively, of a sample pan in a device used to unseal the sample pan.

FIGS. 11A to 11D are perspective and cross-sectional views of another example of a sample pan in a device used to unseal the sample pan.

FIG. 12 is a flowchart representation of another example of a method for preparing a sample for a thermal analysis instrument.

### DETAILED DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Those of ordinary skill having access to the teaching herein will recognize additional implementations, modifications, and embodiments, as well as other fields of use, which are within the scope of the present disclosure as described herein.

In brief overview, embodiments and examples disclosed herein are directed to a sample pan for a thermal analysis instrument and a device for unsealing a sample pan. The sample pan includes a sealing element that opens when the sample pan is inside the instrument by controlling the temperature of the instrument. Typically, a sample pan is loaded with a sample to be tested while the sample pan is in an inert gas environment. The sample pan is then sealed inside the inert gas environment, then taken out of the inert environment and loaded into the instrument before closing the instrument and purging the environment inside the instrument. Once the desired instrument environment is reached, the instrument temperature is changed to just above a transition temperature for the sealing element so that the sample pan is unsealed to expose the sample to the instrument environment. Alternatively, a device used to unseal a sample pan includes an actuator element that changes shape at a transition temperature such that a punch element coupled to the actuator element moves to puncture the sealing element and expose the sample. Subsequent to either implementation, the instrument is operated to acquire measurement data for the sample across a range of temperatures.

As used herein, a “thermal analysis instrument” means an instrument that is used to determine one or more properties of a sample as a function of temperature. By way of non-limiting examples, the thermal analysis instrument may be a thermogravimetric analyzer (TGA) or a differential scanning calorimeter (DSC). A “sample pan” means a container that holds a sample for measurement by a thermal analysis instrument. Sample pans can have a variety of shapes and may include a pan body formed as a single part or body. Alternatively, sample pans may include two or more pan body parts that are secured to each other to form the sample pan.

The term “gas path” is used herein to mean a defined path between two regions through which a gas or a mixture of gases may pass. For example, a gas path may be defined by one or more channels (e.g., openings) in or through a solid body such that the environment at one end of the gas path is in communication with and exposed to the environment at the other end of the gas path through the channels.

A “shape memory material” means a metal, alloy or polymer that can be deformed when cold but will return to its pre-deformed shape, that is, its remembered shape, when heated to a sufficient temperature, i.e., heated to a temperature equal to or greater than a transition temperature. As used herein, “transition temperature” means the temperature at which the shape of a component formed of the shape memory material changes. The transition temperature can be altered by changing the material composition of the shape memory material.

Examples provided below are discussed primarily with respect to memory metals and alloys; however, it should be realized that shape memory polymers may instead be used in some implementations, depending on temperature and shape change considerations. Non-limiting examples of shape memory metals include nickel-titanium and copper-aluminum-nickel. Shape memory material components described herein may exhibit either a one-way memory effect or a two-way memory effect. For a one-way shape memory material, a component heated to or above its transition temperature changes from its lower temperature deformed shape to its remembered shape; however, subsequent cooling to less than the transition temperature does not result in the component reverting to its deformed shape. For a two-way shape memory metal, a component changes from a first remembered shape to a second remembered shape when heated to or above the transition temperature and reverts to the first remembered shape when cooled to less than the transition temperature. Embodiments described herein may utilize shape memory metal components that exhibit either effect.

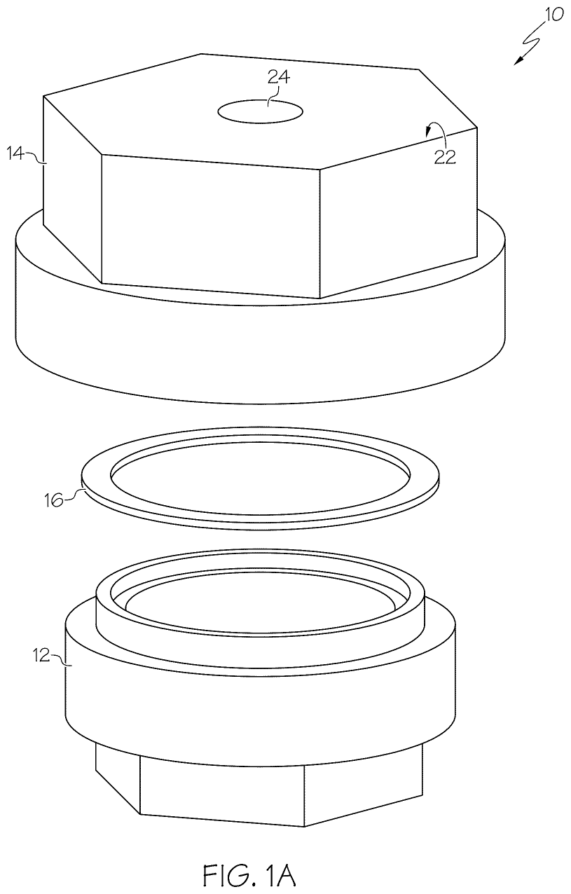

FIG. 1A is an exploded view of an example of a sample pan 10 for a thermal analysis instrument. FIGS. 1B and 1C are cross-sectional views of the sample pan 10 in a hermetically sealed state and an unsealed state, respectively.

The sample pan 10 includes a lower pan body 12 and an upper pan body 14 which can be secured to each other after loading a sample into the lower pan body 12. In one embodiment, the lower and upper pan bodies 12, 14 are made of stainless steel. In certain non-limiting alternative embodiments, the pan bodies 12, 14 are made from gold, aluminum, copper, ceramic or quartz. An optional gasket 16 may be included to improve the hermetic seal. The gasket 16 may be a gold-coated copper gasket or a gasket formed of a soft metal such as gold, silver, copper or aluminum. The pan bodies 12, 14 may be attached to each other via complementary threaded portions.

When attached, the lower and upper pan bodies 12 and 14 define a pan body having an internal volume that includes the sample to be tested. An opening 18 in the upper pan body 14 defines a gas path that extends from the internal volume to an external surface 22. A scaling element 24 disposed in the opening 18 blocks (i.e., obstructs) the gas path when the sample pan 10 is in a hermetically sealed state (FIG. 1B). Thus, the sample is not exposed to the external environment of the sample pan 10. The sealing element 24 may partially or fully occupy the length of the opening 18 and in some alternative embodiments the sealing element 24 extends outward from one or both ends of the opening 18.

The sealing element 24 is formed of a thermally sensitive material that changes shape in response to a change in temperature. The change in shape occurs when the temperature increases or decreases to the transition temperature for the element 24. When the temperature of the external environment, which is the internal environment of the thermal analysis instrument when the sample pan resides in the instrument, reaches the transition temperature the change in the shape of the sealing element 24 results in partial or full removal of the obstruction in the opening 18 so that the sample is exposed to the external environment. In one embodiment, the sealing element 24 is a plug made of a metal or other material having a transition temperature defined as the melting temperature of the material. Thus, the melting of the plug and the resulting change in the shape of the plug releases the plug from the opening 18 via gravity.

The partially or fully melted plug 24 is captured by a cup 26 disposed below the bottom of the opening 18. In the illustrated example, the cup 26 is integral with the remainder of the upper pan body 14. The gas path between the internal volume and external environment includes the opening 18 (e.g., a vertical bore) 18 that is obstructed by the plug 24 and further includes horizontal channels 28A and 28B in the upper pan body 14 in a region that extends downward toward the cup 26. When the plug 24 is released and falls below the horizontal channels 28 and into the cup 26, the opening 18 is unobstructed and the internal volume and external environment are in communication. In an embodiment in which no cup is provided, the melted plug falls to the bottom internal surface of the lower pan body 12.

The transition temperature at which the solid plug 24 melts is selected to be in a range of temperatures that is above the ambient temperature where the thermal analysis instrument is located and the environment (e.g., glove box) in which the sample pan 10 is loaded with the sample. Additionally, the transition temperature is less than the lowest temperature in the measurement temperature range of the instrument during sample measurements. After loading the sample pan 10 into the instrument and purging the internal environment, the internal temperature is increased to equal or exceed the transition temperature while remaining less than the lowest temperature in the measurement temperature range. Thus, the sample can be exposed to the purged environment before initiating a temperature ramp for sample measurements. The purged environment may include one or more inert gases such as argon and nitrogen.

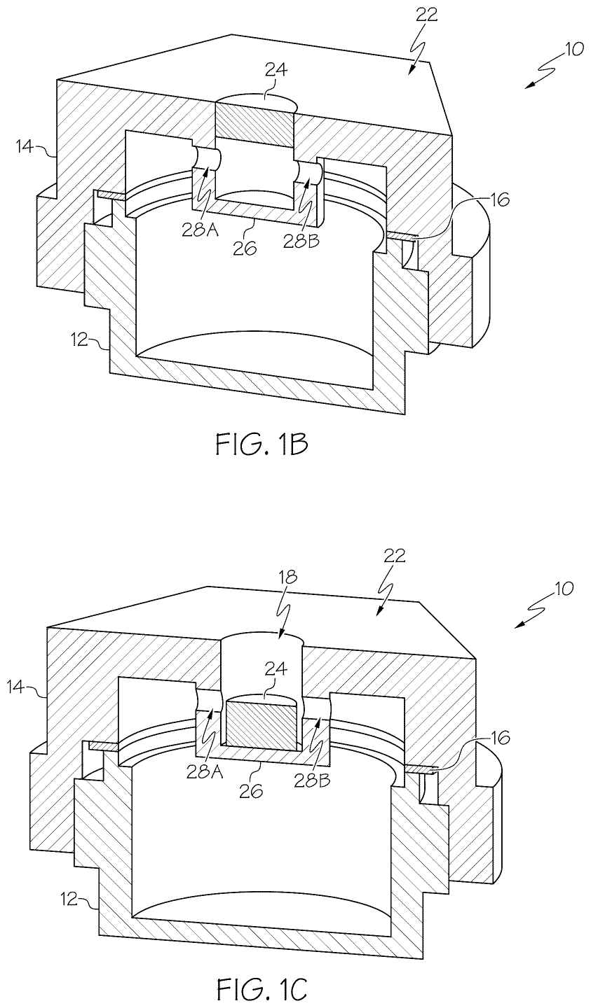

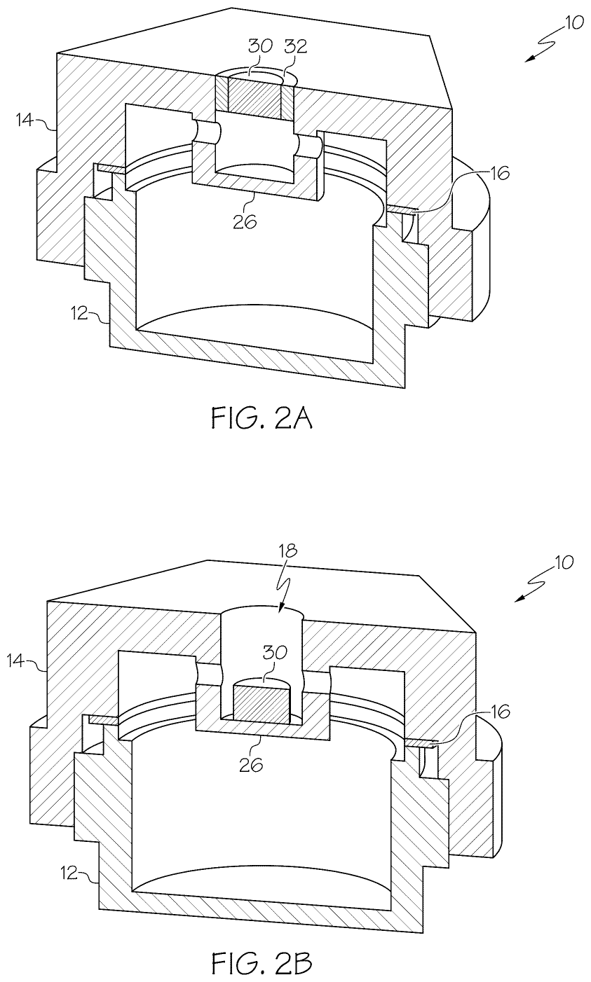

In an alternative configuration to those described with respect to FIGS. 1A-IC, the plug may be formed of a material that does not change shape with a change in temperature; however, in this configuration the plug includes a layer of a material that melts at the transition temperature. For example, the plug may be a metallic plug 30, such as a stainless steel plug, having at least one surface coated with a layer 32 of meltable material, such as a low-melting point alloy, as shown in FIG. 2A. The plug 30 is cylindrical in shape and is sized to easily pass through the opening 18; however, when coated on its curved surface with the layer 32 of meltable material, the coated plug is larger than the opening 18 and is pressed inside the opening 18 to create an air-tight seal. In another embodiment, the plug is tapered to be wider at the top than at the bottom and a portion of the plug extends above the top of the opening 18. In other embodiments additional surfaces of the plug or the entire plug may be coated. Referring again to the illustrated example, the effective reduction in the diameter of the coated plug is reduced during melting, causing the metallic plug 30 to be released into the cup 26.

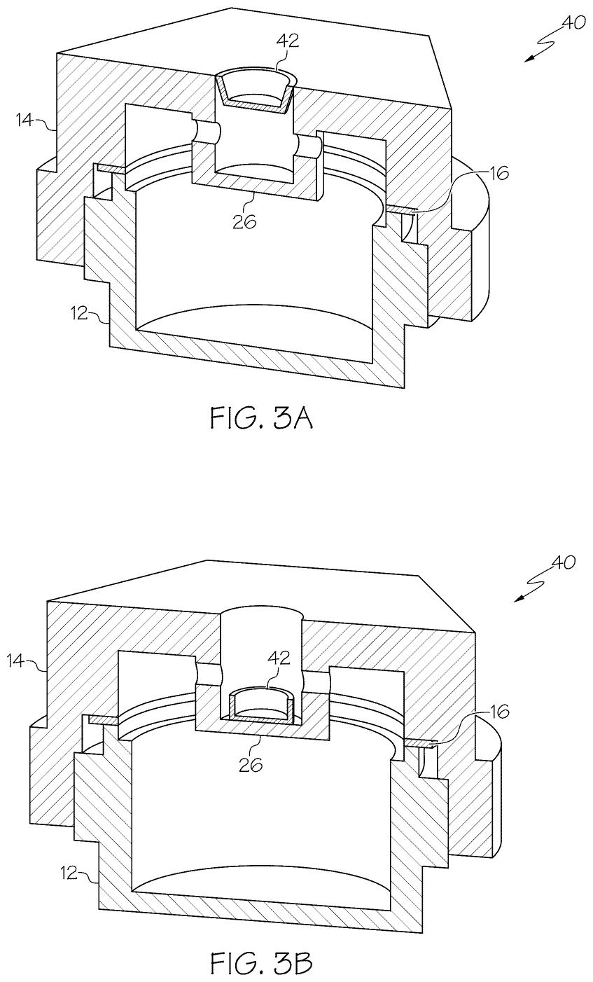

FIGS. 3A and 3B are cross-sectional views of a sample pan 40 in a hermetically sealed state and an unsealed state, respectively. The sample pan 40 may be structurally similar to the sample pan 10 of FIGS. 1A-1C; however, the sealing element is a shape memory metal plug 42. In FIG. 3A, the plug 42 is shaped as a “pie pan” having a diameter at the top that is greater than the diameter at the base. When the internal temperature of the thermal analysis instrument increases to a transition temperature or a slightly greater temperature, the shape of the plug 42 changes to its “remembered” shape, as shown in FIG. 3B where the diameter at the top of the plug 42 is decreased. Consequently, the plug 42 drops from the upper pan body 14 into the cup 26. It will be recognized that in other embodiments the geometry of the bore and the plug may be different to achieve a release of the plug 42 with sufficient heating. The plug 42 may have a different shape as long as the initial shape permits the plug 42 to fully obstruct the bore and the changed shape enables the plug 42 to drop by gravity into the cup 26.

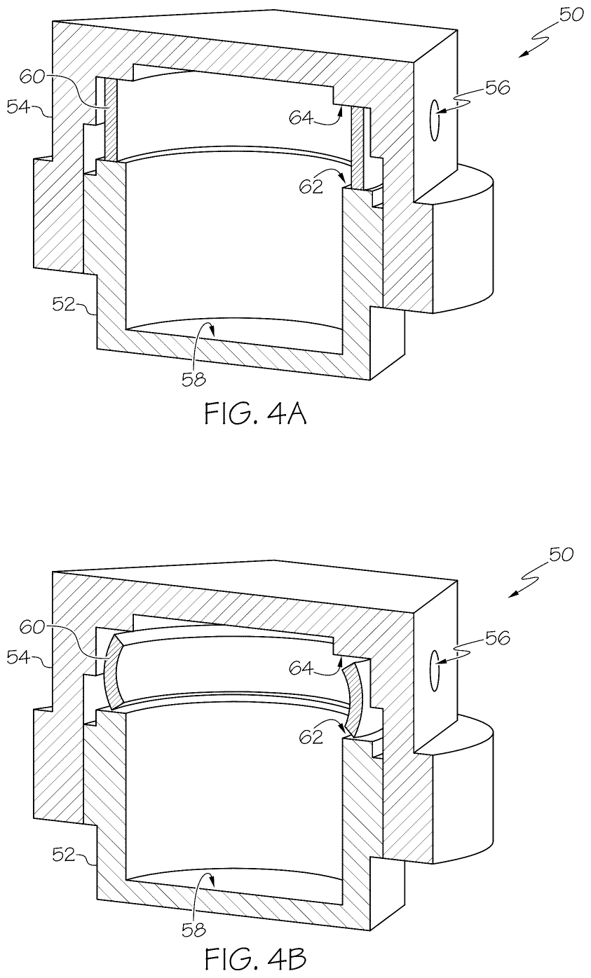

In another example shown in FIG. 4A, a cross-sectional view of a sample pan 50 is shown in a hermetically sealed state. The sample pan 50 includes a lower pan body 52 and an upper pan body 54 having a channel 56. The channel 56 provides a gas path from the inside to the outside of the upper pan body 54. In alternative embodiments, there may be two or more channels through the upper pan body 54. An internal surface 58 on the lower pan body 52 receives the sample during the sample loading process before the lower and upper pan bodies 52, 54 are attached to each other. A sealing element 60 in the form of a seal ring extends from a top surface 62 of the lower pan body 52 to an inner surface 64 of the upper pan body 54. The seal ring 60 is made of a shape memory metal that changes to a “remembered shape” once the temperature is increased to at least its transition temperature. The internal volume that may include a sample for evaluation is defined by the lower pan body 52, seal ring 60 and upper pan body 54. The seal ring 60 is shaped as a thin cylindrical wall and prevents the internal volume from communicating with the external environment through the channel 56.

As the temperature of the external environment reaches or surpasses the transition temperature, the shape of the seal ring 60 changes to its remembered shape as shown in FIG. 4B. The seal ring 60 collapses (i.e., buckles radially outward) so that the ring height decreases to create a gap between the top of the seal ring 60 and the inner surface 64 of the upper pan body 54. This gap allows the internal volume to communicate with the external environment through a gas path over the top of the seal ring 60 and out through the channel 56. Thus, the shape change of the seal ring 60 unseals the sample pan 50.

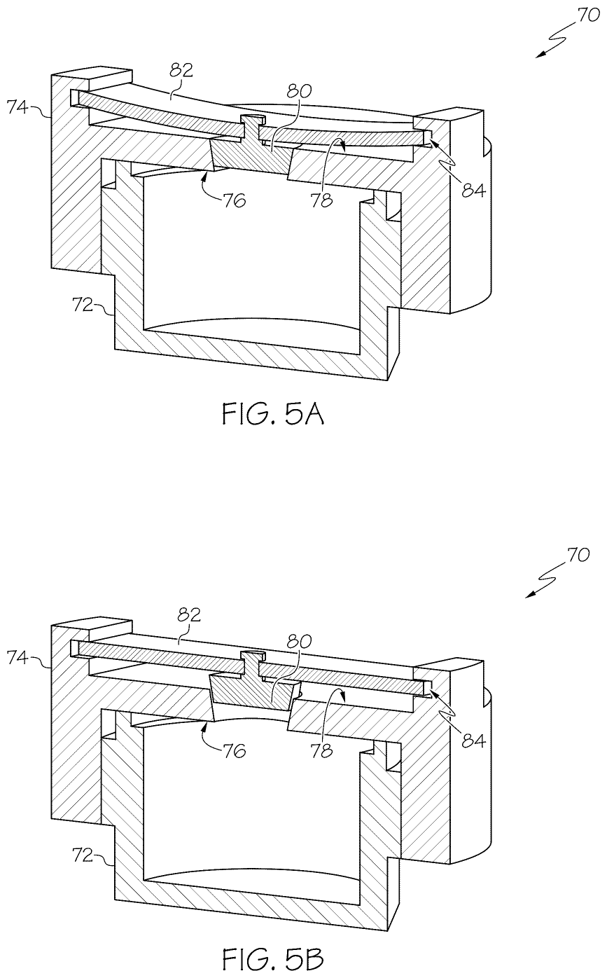

In another example, a sample pan 70 is shown in a hermetically sealed state in the cross-sectional view provided in FIG. 5A. The sample pan 70 includes a lower pan body 72, an upper pan body 74 having an opening between an internal surface 76 and an external surface 78, a seal plug 80 and an actuator element 82. The side of the opening is tapered to receive and engage with a tapered side of the seal plug 80. The actuator element 82 is a shape memory metal component in the shape of a bowed plate having a convex lower surface and concave upper surface. The actuator element 82 is held in position by a groove 84 in the upper pan body 74 that captures the element ends. The seal plug 80 is coupled to the center of the actuator element 82 and is positioned in the opening. Thus, the internal volume defined between the lower and upper pan bodies 72, 74 is sealed by the seal plug 80.

Increasing the temperature of the external environment to equal or exceed the transition temperature causes the actuator element 82 to revert to its “remembered” shape as shown in FIG. 5B. This shape changes causes the seal plug 80 to be lifted upward and out from the opening. As a result, a gap is created between the side of the seal plug 80 and the surface of the upper pan body 74 along the opening. Thus, the lifting of the seal plug 80 results in the unsealing of the sample pan 70.

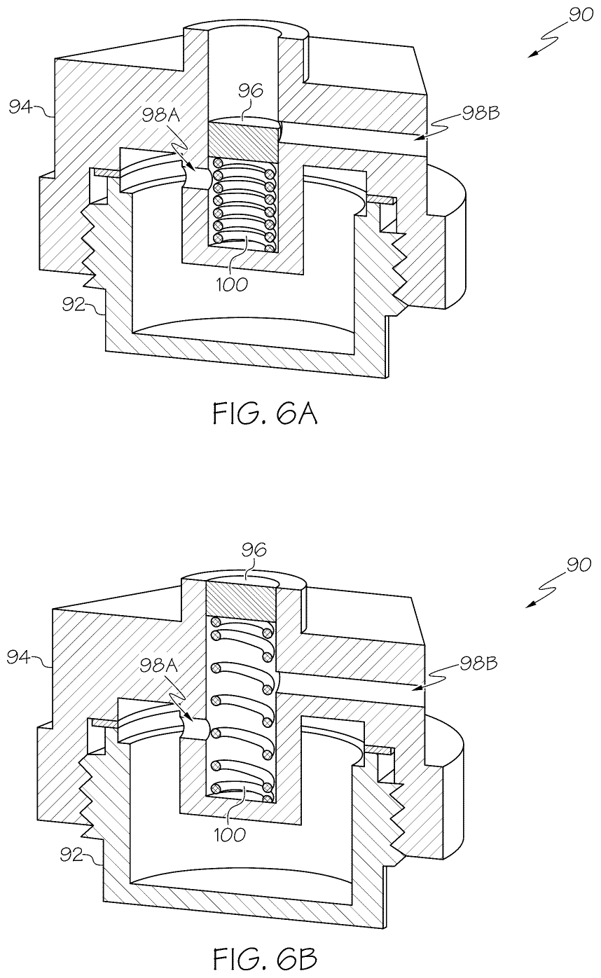

FIGS. 6A and 6B show cross-sectional views of another example of a sample pan 90 in a hermetically sealed state and an unsealed state, respectively. In this example, the sample pan 90 includes a lower pan body 92, an upper pan body 94 and a seal plug 96. The upper pan body 94 includes a bore closed at the lower end. A pair of horizontal channels 98A and 98B are formed in the upper pan body 94 to allow the internal volume to communicate with the external environment. A shape memory metal spring 100 is disposed in the bore so that one end is against the bottom of the bore while the other end is in contact with the seal plug 96. In FIG. 6A, the seal plug 96 is positioned to obstruct the gas path defined by the lower channel 98A, bore and upper channel 98B. Once the transition temperature for the spring 100 is reached or exceeded, the spring 100 reverts to an extended shape as shown in FIG. 6B. This expansion of the spring 100 results in movement of the seal plug 96 to a position higher in the bore so that the gas path obstruction is removed and the sample pan 90 is unsealed.

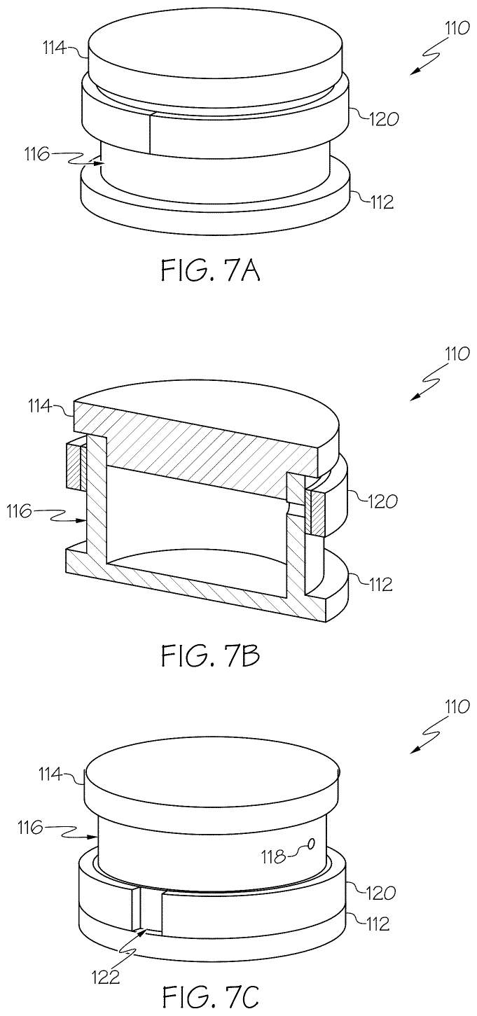

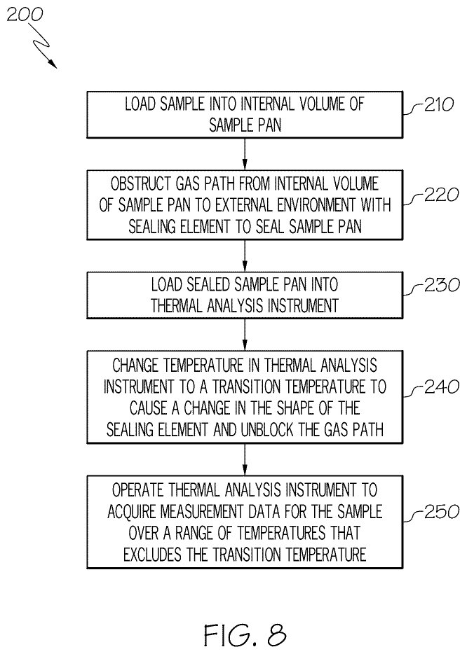

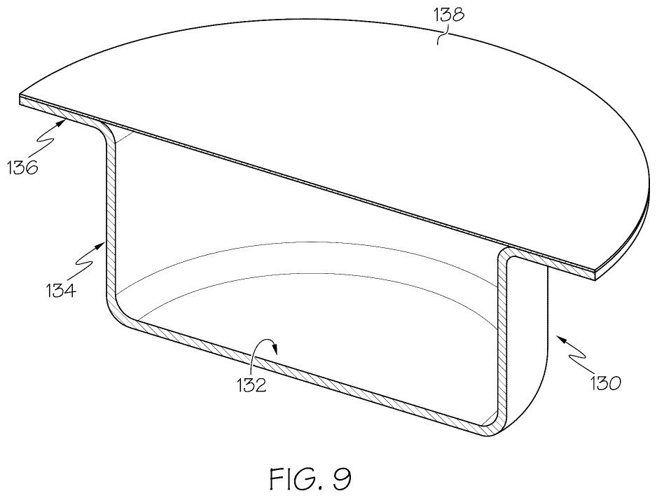

FIGS. 7A and 7B show a perspective view and cross-sectional perspective view, respectively of another example of a sample pan 110 in a hermetically sealed state. FIG. 7C shows a perspective view of the sample pan 110 in an unsealed state. The sample pan 110 includes a lower pan body 112 and an upper pan body 114 that together define the internal volume that includes the loaded sample. The lower pan body 112 includes, in part, a circumferential wall 116 and a gas path in the form of a channel 118 in the wall 116 to expose the internal volume to the external environment. In other examples, multiple channels may be provided through the wall 116. The sample pan 110 further includes a seal ring 120 comprised of a two-way shape memory metal that is “trained” to actuate (change shape) from a first remembered shape to a second remembered shape when heated to a transition temperature and to revert to the first remembered shape when cooled to less than the transition temperature. It should be recognized that the transition temperature when heating may be different than the transition temperature when cooling may be similar, but not identical, due to hysteresis. The seal ring 120 may be “C-shaped” such that there is a gap 122 between two ends although in alternative embodiments the ring may be continuous, that is, there is no gap.

During sample installation for a TGA system, the seal ring 120 is positioned over the channel 118 and cooled to the lower transition temperature to secure the seal ring 120 in place on the lower pan body 112 before loading the sample and securing the lower pan body 112 and upper pan body 114 to each other. In an alternative loading process, the sample is loaded and the lower pan body 112 and upper pan body 114 are then secured together before the seal ring 120 is placed in position and subsequently secured in place by cooling. Prior to starting measurements, the sample pan 110 is heated inside the thermal analysis instrument to at least the transition temperature to cause the seal ring 120 to expand to a larger internal diameter. As a result, the seal ring 120 falls to the base of the lower pan body 112 and the sample pan 110 is unsealed. It should be noted that a reverse thermal procedure using an appropriate shape memory material in which the seal ring 120 is positioned over the channel 118 and then heated to secure the seal ring 120 in place may be used. The seal ring 120 is later released from its position to unseal the sample pan 110 by cooling. This reverse procedure may not be practical in certain implementations such as for a TGA instrument that is not capable of the necessary cooling capability to unseal the sample pan 110.

In an alternative implementation, the seal ring 120 may be made of a one-way shape memory metal. To seal the sample pan 110, the seal ring 120 is positioned over the channel 118 and manually compressed in place. After loading the sample pan 110 into the thermal analysis instrument, the operating temperature of the instrument is increased as described above to unseal the sample pan 110.

FIG. 8 is a flowchart representation of an example of a method 200 for preparing a sample for a thermal analysis instrument. In some embodiments, the method 200 is performed using one of the sample pans described above although other sample pans appropriately configured may be used.

The method includes loading the sample (210) inside an inert chamber (glove box) into an internal volume of the sample pan. The sample pan may be made of a lower pan body and an upper pan body that, when secured to each other, define the internal volume. Loading the sample may include placing the sample in the lower pan body before securing the upper pan body to the lower pan body. A gas path through the sample pan is obstructed (220) to prevent a continuous path between the internal volume and the external environment. In some embodiments, the obstructing (220) of the gas path is performed before the sample is loaded into the internal volume. For example, the sealing element may be positioned in or on the upper pan body to obstruct a gas path channel before attaching the lower and upper pan bodies to each other.

The method 200 continues by taking the loaded and sealed sample pan out of the glove box and loading (230) the sample pan into the thermal analysis instrument. Subsequently, the instrument is operated (240) to control the temperature of the environment around the sample pan (i.e., the external environment) and then change the temperature to a transition temperature at which a shape of the sealing element changes. The shape change at least partially removes the obstruction in the gas path, thereby unsealing the sample pan and allowing the internal volume to communicate with the external environment. Once the sample pan is unsealed and exposed to the controlled gas and temperature environment of the thermal analysis instrument, the instrument may be operated to perform sample measurements across a range of temperatures.

In the examples described above, the gas path is in the form of an opening or other form of channel and may include one or more channel segments to allow the internal volume to be in communication with the external environment. It will be recognized that the gas path can take on other structural configurations. For example, the cross-sectional area along the length of the opening does not have to be circular and the cross-sectional size and shape can vary along the length of the opening or channel.

In contrast to the sample pans described above, a sample pan 130 may be in the form shown in FIG. 9. The sample pan 130 is nominally shaped as a cup or other receptacle having an opening at the top. The sample pan 130 includes an integral unit having a base 132, a cylindrical side wall 134 and a flange 136 extending outward and away from the cylindrical side wall 134. As described above with other implementations of a sample pan, an internal volume of the sample pan 130 is adapted to receive a sample to be tested. The internal volume is defined as the region surrounded by the base 132, cylindrical side wall 134 and a sealing element 138 attached to the flange 136. The sealing element 138 hermetically seals the internal volume. In some implementations, the sealing element is a foil. By way of non-limiting examples, the foil may be a gold foil or an aluminum foil.

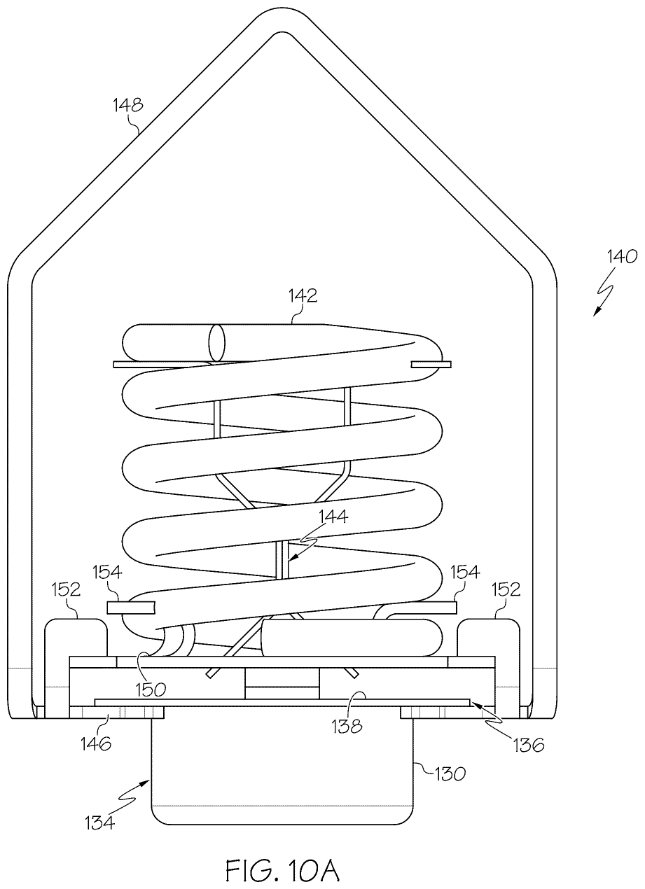

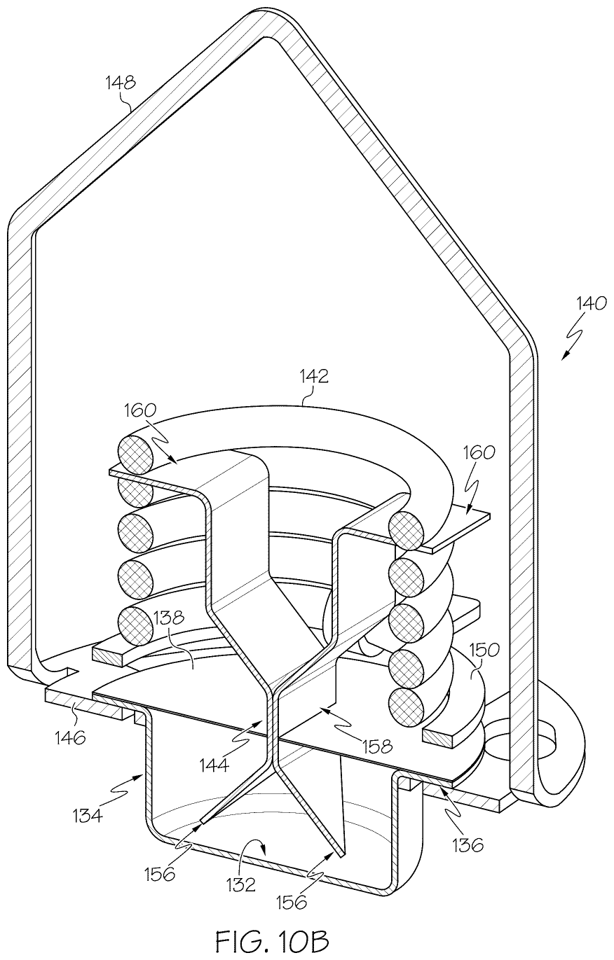

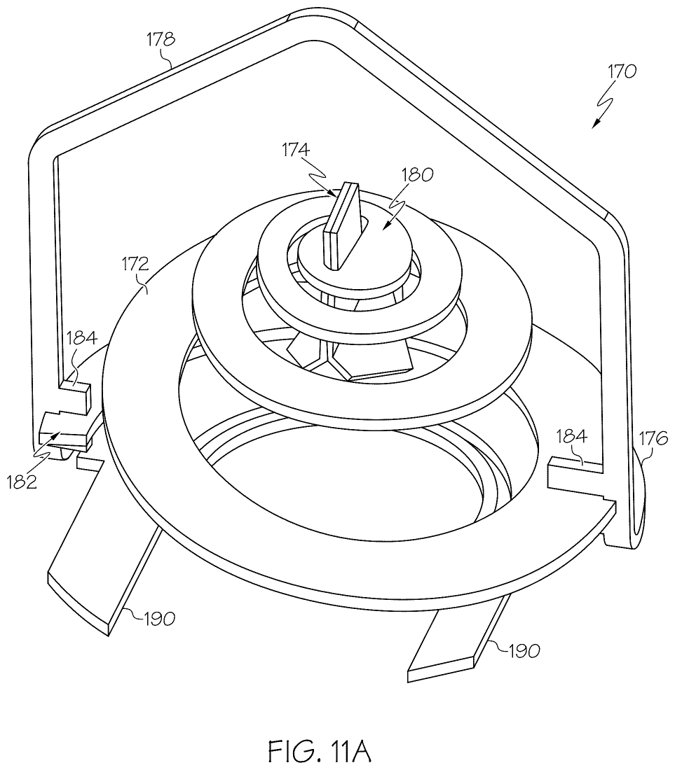

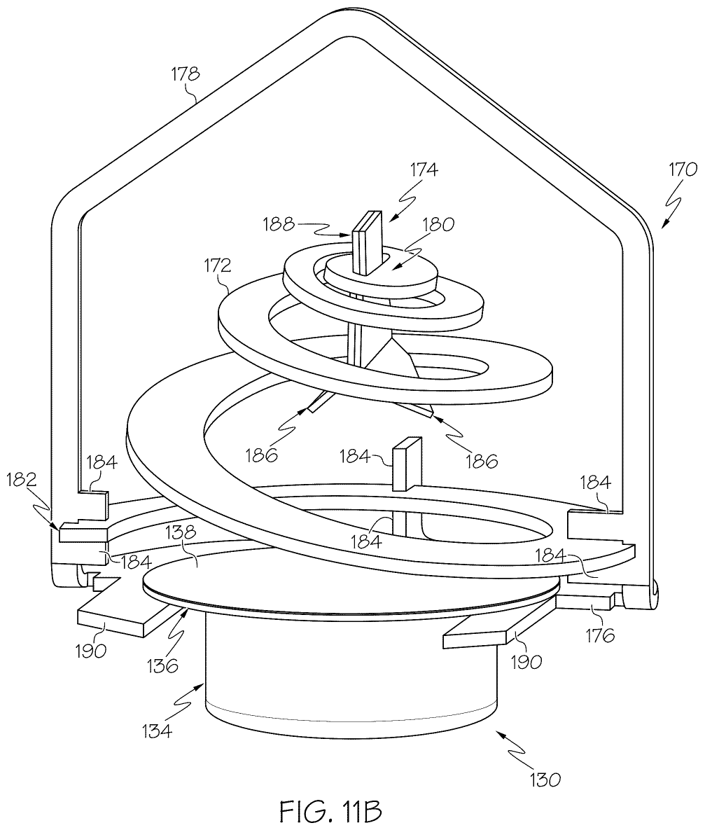

FIGS. 10A and 10B are a side view and a cross-sectional perspective view, respectively, of a sample pan 130 held in a device 140 used to unseal the sample pan by puncturing the sealing element 138. FIG. 10A shows the sample pan 130 inserted in the device 140 and remaining in a scaled condition while FIG. 10B shows the device 140 in a changed state that results in the puncture of the sealing element 138 to thereby expose sample in the internal volume to the external environment.

The device 140 includes a sample pan holder configured to secure the sample pan 130 in a fixed position. The device 140 further includes an actuator element and a punch element 144. In the illustrated embodiment, the actuator element is a coil spring 142 made of a shape memory metal. The sample pan holder includes a base 146 and a handle 148. The base 146 has an opening to pass the cylindrical side wall 134 of the sample pan 130 while the flange 136 is positioned against the top surface of the base 146. In some implementations, the base 146 and the handle 148 may be made from sheet metal pressed or bent into final form. A retainer 150 is secured to the base 146 by tabs 152 formed in the base. The retainer 150 includes retainer extensions 154 shaped to engage and secure the lower portion of the coil spring 142.

As more clearly seen in FIG. 10B, the punch element 144 includes a lower portion comprising sections 156 that splay outward, a middle section 158 that extends vertically and an upper section that is separated as two arms 160 that are bent horizontally at their ends. The two arms 160 engage the coil spring 142 near the upper end to thereby couple the punch element 144 to the coil spring 142 so that a change in the shape of the coil spring 142 (e.g., expansion or contraction in length) results in a change in the vertical position of the coil spiring 142, causing the punch element 144 to move in a vertical direction.

In use, the device 140 and sealed sample pan 130 are loaded into a thermal analysis instrument for sample measurement. When the temperature of the external environment (i.e., the internal temperature of the thermal analysis instrument) reaches a transition temperature for the shape memory metal, the coil spring 142 changes from an extended shape shown in FIG. 10A to a compact shape shown in FIG. 10B. During this change in shape, the punch element 144 is forced downward. The splayed sections 156 at the bottom of the punch element 144 contact the sealing element 138 and continue downward to push through, or puncture, the sealing element 138 and thereby expose the internal volume of the sample pan 130 to the external environment.

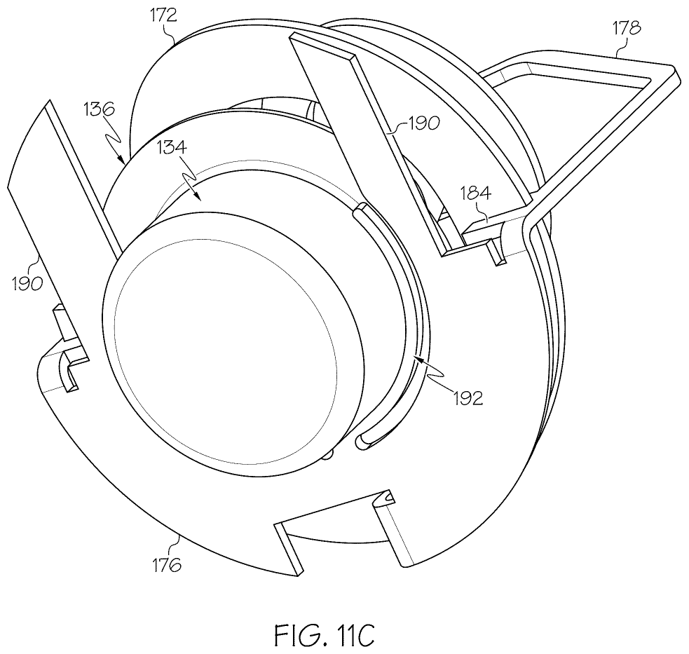

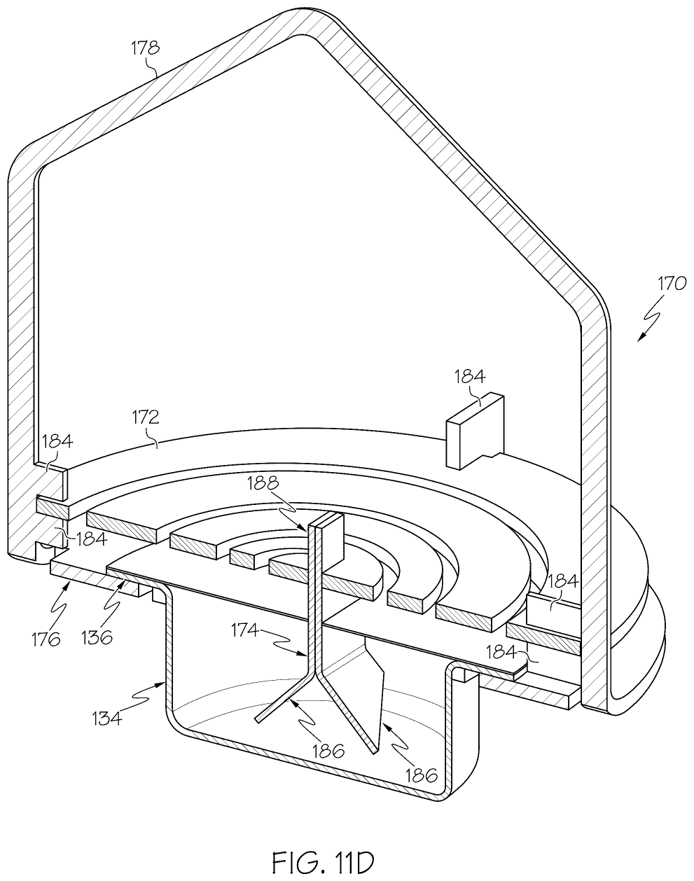

FIGS. 11A-11D show another example of a device 170 used to puncture the sealing element 138 of a sample pan 130. FIG. 11A is a perspective view of the device 170 without any sample pan, FIG. 11B is a perspective view of the device 170 with the hermetically sealed sample pan 130 inserted in place, FIG. 11C is a bottom perspective view of the device 170 and sample pan 130, and FIG. 11D is a perspective view of the device 170 and sample pan 130 after activation to puncture the sealing element 138.

The device 170 includes a sample pan holder configured to secure the sample pan 130 in position relative to an actuator element and punch element 174. In the illustrated embodiment, the actuator element is a spiral coil 172 made of a shape memory metal. In FIGS. 11A-11C, the spiral coil 172 is in a first state in which it is shaped as a conical spiral coil while in FIG. 11D the spiral coil 172 is in a second state where it has the shape of a flat spiral. As used herein, a conical spiral coil means that the outer edge of the spiral coil 172 is nominally tangent to a truncated cone shape and a flat spiral coil means that the entirety of the coil from its inner end 180 to its outer end 182 is substantially planar. The change in the shape of the spiral coil 172 from the first state to the second state occurs as the temperature of the spiral coil 172 changes to reach a transition temperature.

The sample pan holder includes a base 176 and a handle 178. The base 176 has an opening to pass the cylindrical side wall 134 of the sample pan 130 while the flange 136 is positioned against the top surface of the base 176. In one example, the base 176 and the handle 178 are made from sheet metal. The lower portion of the spiral coil 172 is secured in position with respect to the base 176 and handle 178 by passing between paired tabs 184 extending from the base 176 or handle 178.

The punch element 174 includes an upper portion 188 and a lower portion having two sections 186 that splay outward at the bottom. The upper portion 188 is attached to the inner end 180 of the spiral coil 172. In one example, the upper portion 188 may pass through a slot in the inner end 180 and be splayed outward where it extend above the spiral coil 172 to secure the two components together although other means of attachment (e.g., laser welding, epoxying) can be used. Thus, as the coil spring 172 transitions in shape from the first state to the second state, the punch element 174 moves downward toward the base 176.

The sealed sample pan 130 is secured in stable position in the device 170 by sliding the pan 130 between two prongs 190 that extend from the base 176. As shown in FIG. 11C, a pair of curved fingers 192 (only one visible) formed in the base 176 just inside the prongs 190 flex outward to receive the cylindrical side wall 134 and relax back inward to remain in contact with the sample pan 130 once fully inserted. The flange 136 of the sample pan 130 rests against the top surfaces of the base 176 and prongs 190.

The device 170 with the sealed sample pan 130 can be loaded into a thermal analysis instrument for sample measurement. As the internal temperature of the thermal analysis instrument increases to reach a transition temperature for the shape memory metal, the spiral coil 172 changes from its first state shape to that of its second state shape as shown in FIG. 11D. During this change in shape, the punch element 174 is forced downward. The splayed sections 186 at the bottom of the punch element 174 contact the sealing element 138 and continue downward to push through, or puncture, the sealing element 138. Thus, the opening created in the sealing element 138 exposes the internal volume of the sample pan 130 to the external environment.

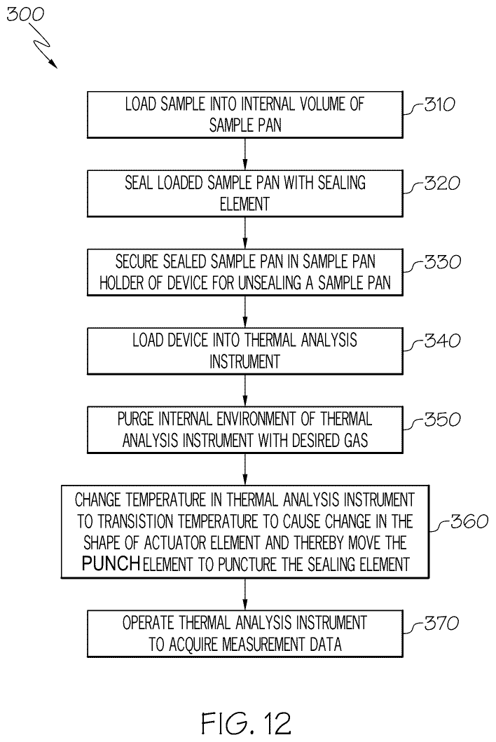

FIG. 12 is a flowchart representation of an example of a method 300 for preparing a sample for a thermal analysis instrument. The method 300 may be performed, for example, using the sample pan 130 and devices 140 or 170 of FIGS. 10A-11D which are referenced in the description below.

The method 300 includes loading (310) the sample inside an inert chamber, such as a glove box, into an internal volume of a sample pan. The sample pan 130 is then hermetically scaled (320) with a sealing element 138 such as a foil seal. The sealed sample pan 130 is secured (330) within the sample pan holder of a device 140, 170 that operates to unseal the sample pan 130. Installing the sample pan 130 into the device 140, 170 can be done at the inert chamber or at another convenient location as the sample is now protected from the ambient environment. Subsequently, the device 140,170 is installed (340) inside a thermal analysis instrument.

Prior to operating the thermal analysis instrument to obtain sample measurement data, the instrument internal environment (e.g., furnace environment) is purged (350) with a user selected gas to achieve the desired environment for later sample exposure. Subsequently, the instrument temperature is changed (360) (e.g., increased) to cause a change in the shape of the device actuator element 142, 172 which in turn moves the punch element 144, 174, resulting in a puncture of the sealing element 138. Consequently, the sample is exposed to the internal environment of the instrument which can now be operated (370) to acquire measurement data. For example, the temperature of the instrument may be changed to a starting temperature and the temperature then increased over time while measurement data are acquired.

It should be recognized that the device used to unseal the sample pan according to the method 300 may differ from the devices 140, 170 described above without departing from the principles described herein. For example, other forms of actuator elements that change shape when their temperature reaches a transition temperature may be used. Similarly, the punch element may vary from those described above both in terms of structural configuration and how the punch element is coupled to the actuator element. In another example, the device for unsealing the sample pan is internal to the sample pan. In this configuration, the device includes a punch element and an actuator element that are both inside the sample pan and enclosed with the sample by the sealing element. When the transition temperature is reached, the actuator element changes shape to push the punch element upward to push through, or puncture, the scaling element.

In the examples described above an increase in temperature is generally used to unseal the sample pan; however, it will be appreciated that in alternative embodiments a decrease in temperature may be used to unseal a sample pan. In such implementations, the shape change to the sealing element of the sample pan caused by the decreased temperature is used to remove the obstruction to the gas path between the internal volume of the sample pan and the external environment. Alternatively, for a device used for unsealing a sample pan, the shape change of the actuator element caused by the decreased temperature may enable the sealing element to be punctured. For example, the sealing element or actuator element may be an element made of a shape memory metal having a transition temperature that is less than an ambient environment such that cooling is used to unseal a sample pan. One example of an instrument that can benefit from such a sealing element or actuator element is a sorption analyzer where the sample may be cooled to less than ambient temperature.

While numerous examples have been shown and described, the description is intended to be exemplary, rather than limiting and it should be understood by those of ordinary skill in the art that various changes in form and detail may be made therein without departing from the scope of the invention as recited in the accompanying claims.

What is claimed is:

1. A sample pan for a thermal analysis instrument, comprising:
a pan body having an internal volume to receive a sample and a gas path extending from the internal volume to an external surface of the pan body;
a sealing element disposed in the gas path to obstruct the gas path and thereby seal the internal volume from an external environment, the sealing element comprising a thermally sensitive material that changes a shape of the sealing element in response to a change in a temperature of the external environment to a transition temperature, wherein the change in shape exposes the internal volume to the external environment through the gas path.

2. The sample pan of claim 1, wherein the sealing element comprises a plug made of a shape memory material.

3. The sample pan of claim 1, wherein the sealing element is disposed on the external surface of the pan body at an end of the gas path.

4. The sample pan of claim 3, wherein the sealing element is a seal ring disposed between internal surfaces of the pan body.

5. The sample pan of claim 3, wherein the pan body has a circumferential wall with a channel therein and wherein the sealing element is a seal ring disposed on the external surface of the circumferential wall.

6. The sample pan of claim 1, wherein the sealing element comprises a plug made of a material having a melting temperature at the transition temperature.

7. The sample pan of claim 1, wherein the sealing element comprises a metallic plug having a surface with a meltable layer formed thereon.

8. The sample pan of claim 1, wherein the sealing element comprises:
a plug disposed in the gas path; and
an actuator element coupled to the plug and made of a shape memory material, the actuator element having a shape that changes in response to the change in the temperature of the external environment to a transition temperature and wherein a change in the shape of the actuator element removes the plug from the gas path.

9. The sample pan of claim 8, wherein the actuator element is a spring made of a shape memory metal.

10. The sample pan of claim 1, wherein the sample pan holds a sample during measurement by a thermal analysis instrument and the transition temperature is less than a lowest temperature in a measurement temperature range.

11. A method for preparing a sample for a thermal analysis instrument, the method comprising:
loading a sample into an internal volume of a sample pan, the sample pan having a gas path from the internal volume through the sample pan to an external environment;
sealing the sample in the sample pan with a sealing element that obstructs the gas path from the internal volume to the external environment, the sealing element comprising a thermally sensitive material that changes a shape of the sealing element in response to a change in a temperature of the external environment to a transition temperature;
loading the sample pan into the thermal analysis instrument; and
operating the thermal analysis instrument to change a temperature of the external environment of the sample pan to at least the transition temperature, wherein the change in the shape removes the obstruction from the gas path so that the internal volume communicates with the external environment.

12. The method of claim 11, wherein the external environment is defined inside the thermal analysis instrument, the method further comprising purging the external environment with a user-selected gas after the loading of the sample pan into the thermal analysis instrument and before operating the thermal analysis instrument to change the temperature of the external environment.

13. The method of claim 11 wherein operating the thermal analysis instrument comprises increasing the temperature of the external environment of the sample pan.

14. The method of claim 11 wherein operating the thermal analysis instrument comprises decreasing the temperature of the external environment of the sample pan.

15. The method of claim 11 further comprising operating the thermal analysis instrument to change the temperature through a measurement temperature range that does not include the transition temperature.

16. A device for unsealing a sample pan for a thermal analysis instrument, comprising:
a sample pan holder configured to secure a sample pan in a fixed position with respect to the sample pan holder;
an actuator element secured to the sample pan holder and being formed of a thermally sensitive material that changes a shape of the actuator element in response to a change in an external temperature to a transition temperature; and
a punch element attached to the actuator element and disposed at a position with respect to the sample pan such that the change in the shape of the actuator element in response to the change in the external temperature moves the punch element to puncture the sealing element to thereby expose the internal volume of the sample pan to an external environment.

17. The device of claim 16 wherein the actuator element is a coil spring made of a shape memory metal.

18. The device of claim 17 wherein the change in the shape of the actuator element is a change in a length of the coil spring.

19. The device of claim 16 wherein the actuator element is a spiral coil made of a shape memory metal.

20. The device of claim 19 wherein a change in the shape of the actuator element is a change from a non-planar configuration of the spiral coil to a planar configuration.

21. A method for preparing a sample for a thermal analysis instrument, the method comprising:
securing a sample pan in a device for unsealing the sample pan, the device comprising
a sample pan holder configured to secure a sample pan in a fixed position with respect to the sample pan holder;
an actuator element secured to the sample pan holder and being formed of a thermally sensitive material that changes a shape of the actuator element in response to a change in an external temperature to a transition temperature; and
a punch element attached to the actuator element and disposed at a position with respect to the sample pan such that the change in the shape of the actuator element in response to the change in the external temperature moves the punch element to puncture a sealing element on the sample pan to thereby expose the internal volume of the sample pan to an external environment;
loading the device into a thermal analysis instrument;
changing a temperature of the thermal analysis instrument to a transition temperature to change the shape of the actuator element wherein the punch element moves to puncture the sealing element.

22. The method of claim 21, wherein the actuator element is a coil spring and wherein the change in the shape of the actuator element is a change in a length of the coil spring.

23. The method of claim 21, wherein the actuator element is a spiral coil and the change in the shape of the actuator element is a change from a non-planar configuration of the spiral coil to a planar configuration.
